(19) United States
(12) Patent Application Publication
(10) Pub. No.: US 2025/0129447 A1
(43) Pub. Date: Apr. 24, 2025

(54) METHODFOR MANUFACTURING NANOCRYSTAL ALLOY RIBBON, AND METHOD FOR MANUFACTURING MAGNETIC SHEET

(71) Applicant: PROTERIAL, LTD., Tokyo (JP)

(72) Inventors: Yuichi OGAWA, Tokyo (JP); Kotoba TOYONAGA, Tokyo (JP); Kouhei MYANO, Tokyo (JP); Yasuo KURIYAMA, Tokyo (JP); Takeshi FUKUYAMA, Tokyo (JP); Jun WADA, Tokyo (JP)

(21) Appl. No.: 18/852,692

(22) PCT Filed: Mar. 30, 2023
(86) PCT No.: PCT/JP2023/013352

§ 371 Date: Sep. 30, 2024

(30) Foreign Application Priority Data
Mar. 30, 2022 (JP) 2022-055681
Mar. 30, 2022 (JP) 2022-055682

(51) Int. Cl. C21D 9/52; C21D 6/00; C22C 38/00; C22C 38/02; C22C 38/12; C22C 38/16; H01F 41/02

(52) U.S. Cl. CPC C21D 9/52; C21D 6/008; C22C 38/002; C22C 38/02; C22C 38/12; C22C 38/16; H01F 41/0213; C21D 2201/03; C22C 2200/04; C22C 2202/02

(57) ABSTRACT

A nanocrystalline alloy ribbon is provided. In a method for manufacturing a nanocrystalline alloy ribbon, when a non-crystalline alloy ribbon is brought into contact with a heating body and heated, the heating body is heated to a heating temperature Ta of Tx1+80° C. or more and Tx1+230° C. or less, where Tx1° C. is a bccFe crystallization starting temperature of the non-crystalline alloy ribbon measured at a heating rate of 20 K/min.

### CROSS-REFERENCE TO RELATED APPLICATION

This international application claims the benefit of Japanese Patent Application Nos. 2022-055681 and 2022-055682 filed on Mar. 30, 2022 in the Japan Patent Office, and the entire disclosures of Japanese Patent Application Nos. 2022-055681 and 2022-055682 are incorporated herein by reference.

### TECHNICAL FIELD

The present disclosure relates to a method for manufacturing a nanocrystalline alloy ribbon having a nanocrystalline structure, and a method for manufacturing a magnetic sheet using the nanocrystalline alloy ribbon.

### BACKGROUND ART

Low magnetostrictive nanocrystalline alloy ribbons having a nanocrystalline structure have been known. The nanocrystalline alloy ribbons have excellent magnetic properties such as high magnetic permeability and low loss, and exhibit these excellent magnetic properties over a wide frequency band. The nanocrystalline alloy ribbons are used in magnetic components such as transformers, motors, choke coils, magnetic shields, and current sensors. Many of these magnetic components have high operating frequencies set in line with the trend towards higher frequencies in semiconductors and other devices. As a result, soft magnetic materials used are increasingly being switched to nanocrystalline alloy ribbons. This is because the nanocrystalline alloy ribbon has a high saturation magnetic flux density of 1.2 T or more, which is the saturation magnetic flux density necessary to achieve further miniaturization of components, and moreover, the nanocrystalline alloy ribbon has excellent properties of low magnetostriction and low loss.

In recent years, contactless charging has been adopted or is being considered for adoption as a charging method for mobile phones, small electrical appliances, electronic devices, electric vehicles, and the like. In a contactless charging device, a nanocrystalline alloy ribbon is sometimes used as a magnetic core of a transmitter/receiver coil or a soft magnetic material for magnetic shielding. Main properties required for soft magnetic material for contactless charging are high magnetic permeability, low loss, high saturation magnetic flux density, and thinness.

Currently, the frequency band mainly used for power transfer in contactless charging is around 100 kHz. The soft magnetic material mainly used is limited to ferrite and nanocrystalline alloy ribbons. The nanocrystalline alloy ribbon is very thin, having a thickness of approximately 20 μm or less, and has a saturation magnetic flux density approximately three times that of ferrite. Thus, the nanocrystalline alloy ribbon is excellent in miniaturization and thinning, and greatly contributes to making a transmitter/receiver coil set small and thin. For these reasons, nanocrystalline alloy ribbons are being adopted or considered for adoption in contactless charging coils in a variety of products.

In contactless charging, there is a tendency for the charging output to be increased in order to shorten the charging time. To address this, for example, it is effective to increase an amount of magnetic flux flowing through the soft magnetic body. Possible methods for compensating for the increase in the amount of magnetic flux include increasing the amount of soft magnetic body used, or switching to a soft magnetic body with higher saturation magnetic flux density. Particularly, the latter is desired, and nanocrystalline alloy ribbons are increasingly being adopted. In addition, in contactless charging, magnetic flux flows from the coil in a thickness direction of the alloy ribbon, and then flows from the center to the outside in the plane. Thus, it is preferable that the nanocrystalline alloy ribbon has isotropic magnetic properties.

On the other hand, when a nanocrystalline alloy ribbon to be used in contactless charging is produced, a non-crystalline alloy ribbon for the nanocrystalline alloy ribbon is produced by casting, and then wound up once. Then, a certain amount of non-crystalline alloy ribbon is unwound from the wound ribbon and rewound onto a core wound into a ring shape. A number of these ribbons are then placed in a heat treatment furnace up to the capacity of the heat treatment furnace and heat treated at a temperature of 550° C. to 580° C. In this manner, a nanocrystalline alloy ribbon was produced. The heat treatment process in this heat treatment furnace took 5 to 8 hours, including cooling. The nanocrystalline alloy ribbon, which has been nanocrystallized by heat treatment, is unwound from the core wound into a ring shape and laminated or stacked to form a magnetic sheet.

The above process adds lamination and stacking steps to the manufacturing process of conventional core products using nanocrystalline alloy ribbons. In case of the manufacturing process of a ring-shaped core product formed by rewinding a ribbon, a core is prepared to match the dimensions of the final product, heat treated, and then sent to a subsequent process. Therefore, there is no unnecessary steps in the aforementioned manufacturing process. However, in case of a magnetic sheet, although a ribbon is rewound to prepare a ring-shaped core for heat treatment, this step is not necessarily essential. The magnetic sheet does not use the ring-shaped core prepared by rewinding the ribbon as is. Thus, rewinding the cast and wound ribbon to prepare a ring-shaped core is an extra process. For this reason, ideally, it is preferable that the magnetic sheet is produced by a process in which the cast ribbon is unwound as is, continuously heat treated, and wound up or laminated or stacked as is.

Japanese Unexamined Patent Application Publication No. 2014-516386 discloses a process of heat treating a non-crystalline alloy ribbon under continuous furnace tensile stress at a temperature Ta satisfying 450° C.≤Ta≤750° C. The composition of the non-crystalline alloy ribbon is Fe_{100-a-b-c-d-x-y-z}CuₐNb_{b}M_{c}T_{d}SiₓB_{y}Z_{z} and up to 1 at % impurities, where M is one or more types of elements Mo, Ta and Zr, T is one or more types of elements V, Mn, Cr, Co and Ni, Z is one or more types of elements C, P and Ge, and 0 at %≤a<1.5 at %, 0 at %≤b<2 at %, 0 at %≤(b+c)<2 at %, 0 at %≤d<5 at %, 10 at %<x<18 at %, 5 at %<y<11 at % and 0 at %≤z<2 at % are satisfied.

Patent Document 2 discloses a method for manufacturing a soft magnetic material that achieves both high saturation magnetization and low coercive force. The soft magnetic material has a composition represented by a composition formula: Fe_{100-a-b-c}B_{d}Cu_{b}M′_{c}, where M′ is at least one type of element selected from a group consisting of Nb, Mo, Ta, W, Ni, and Co, and 10≤a≤16, 0<b≤2, and 0≤c≤8 are satisfied. The soft magnetic material is produced by heating an alloy having a non-crystalline phase at a heating rate of 10° C./sec. or more and holding the alloy at the crystallization starting temperature or more and less than the formation starting temperature of a Fe—B compound for 0 to 80 seconds.

Patent Document 3 discloses a nanocrystalline alloy ribbon. The nanocrystalline alloy ribbon is represented by a composition formula: Fe_{100-a-b-c-d}BₐSi_{b}Cu_{c}M_{d}, where a, b, c, and d are all in at %, and respectively satisfy 0<a, 0<b, 0<c, 0≤d, and 78≤100−a−b−c−d, and M is at least one type of element selected from a group consisting of Ti, Zr, Hf, V, Nb, Ta, Cr, Mo, and W. The nanocrystalline alloy ribbon is produced by continuously running an amorphous alloy ribbon while applying tension F to the amorphous alloy ribbon, and bringing a portion of the amorphous alloy ribbon into contact with a heat transfer medium maintained at a temperature of 450° C. or more. At this time, the temperature of the amorphous alloy ribbon is raised to an attained temperature of 450° C. or more so that the average heating rate in the temperature range from 350° C. to 450° C. is 10° C./sec. or more.

Patent Document 4 discloses a method for treating an amorphous alloy ribbon. In this method, the amorphous alloy ribbon is fed forward along a traveling path at a set feeding speed, and guided so as not to slack. The amorphous alloy ribbon is then heated at a speed exceeding 10³° C./sec. to a temperature to start heat treatment, and the amorphous alloy ribbon is cooled at a speed exceeding 10³° C./sec. until the heat treatment ends. During the heat treatment, a mechanical constraint is applied on the amorphous alloy ribbon until the ribbon adopts a specific shape at rest after the heat treatment. After the heat treatment, the amorphous alloy ribbon is cooled at a speed to preserve the specific shape.

### PRIOR ART DOCUMENTS

### Patent Documents

Patent Document 1: Japanese Unexamined Patent Application Publication No. 2014-516386
Patent Document 2: International Publication No. 2018/025931
Patent Document 3: International Publication No. 2017/150440
Patent Document 4: Japanese Patent No. 6254757

### SUMMARY OF THE INVENTION

### Problems to be Solved by the Invention

In order to continuously heat treat a nanocrystalline alloy ribbon, it is necessary to continuously heat treat the ribbon wound after casting at high temperature after being unwound. In order to increase productivity, the fastest possible speed without breakage is required. Moreover, in order for the nanocrystalline alloy ribbon to have excellent magnetic properties, a fine nanocrystalline structure with an average grain diameter of 50 nm or less and low magnetostriction are necessary. In order to maintain low magnetostriction, a certain amount of Si needs to be added.

Furthermore, magnetic sheets for contactless charging are required to have isotropic magnetic properties, be as free of wrinkles and streaks as possible, which tend to occur during nanocrystallization during heat treatment, and have high space factor.

Patent Document 1 discloses a nanocrystalline alloy ribbon of 1.4 T or more. However, since the heat treatment is performed under tension, anisotropy can be imparted. Further, the magnetic permeability is 3000 or less, and the remanence Jr/Js (Br/Bs) is low at 0.1 or less. For this reason, it is difficult to use the alloy of Patent Document 1 in any products other than those requiring low magnetic permeability. In addition, since the alloy ribbon is not constrained during the heat treatment, wrinkles and streaks are likely to appear in the ribbon during nanocrystallization, which may deteriorate thickness deviation and space factor. Furthermore, portions with wrinkles and streaks can become extremely brittle and may break due to tension.

Patent Document 2 discloses a method in which a non-crystalline alloy is interposed between heated blocks and heated. A series of heat treatment steps, which include interposing the non-crystalline alloy ribbon between the blocks, heating the ribbon, and then removing the non-crystalline alloy, take time. Since the amount that can be treated once is limited, the method is not suitable for heat treating a large amount of ribbons during mass production. In addition, since the ribbon cannot be continuously heat treated, the method is not suitable as a heat treatment method for a magnetic sheet.

Furthermore, since the soft magnetic material described in Patent Document 2 does not contain Si, the SiO₂ film that contributes corrosion resistance of the soft magnetic material is not formed on the material surface. This can make it difficult to inhibit rust and the like.

According to the method described in Patent Document 3, a method in which a ribbon is brought into contact with a heated plate is disclosed. Since heat treatment can be performed while the ribbon is conveyed, mass productivity is high. Excellent magnetic properties can be also obtained. However, although tension is applied to the ribbon to bring the ribbon into uniform contact with the heating plate, ingenuity is required to keep the moving ribbon in uniform contact with the heating plate. Also, since only one side of the ribbon is in contact with the heating plate during conveyance, and the opposite side of the side in contact with the heating plate is not constrained, there is a risk that it is not possible to inhibit generation of wrinkles and streaks due to crystallization upon contact with the heating plate or the ribbon from lifting partially.

Patent Document 4 discloses a method in which a ribbon is brought into contact with a heated roller. Since heat treatment can be performed while the ribbon is conveyed, mass productivity is high. However, since stable heat treatment is achieved by pressing the ribbon against the roller under a large tension of 25 MPa or more, anisotropy may be imparted during the heat treatment, as in Patent Document 1. For this reason, it is not suitable for applications that require isotropy. Also, since only one side of the ribbon is in contact with the heating roller during conveyance, and the opposite side of the side in contact with the heating plate is not constrained, it is not possible to inhibit generation of wrinkles and streaks due to crystallization upon contact with the heating roller or the ribbon from lifting partially. Furthermore, there is a problem in which breakage occurs due to tension.

In addition, the nanocrystalline alloy ribbon is produced by ejecting a molten alloy adjusted to a specific alloy composition onto a rotating cooling roller, rapidly cooling and solidifying the molten alloy to produce an alloy ribbon, and then heat treating the alloy ribbon. The nanocrystalline alloy ribbon is thin, and produced as an elongated ribbon with a specific width. According to this manufacturing method, anisotropy is likely to be introduced in a casting direction (longitudinal direction), and even after heat treatment, the magnetic properties tend to differ between the longitudinal direction of the elongated shape and a width direction orthogonal to the longitudinal direction.

For example, the nanocrystalline alloy ribbon used in stators of motors and magnetic sheets for contactless charging coils are required to be as isotropic as possible. However, as described above, it has been difficult to obtain a nanocrystalline alloy ribbon having excellent magnetic properties (high saturation magnetic flux density, low iron loss) and isotropy by a method of continuous heat treatment and a highly productive method.

The present disclosure provides a manufacturing method for obtaining a nanocrystalline alloy ribbon using a method for continuously heat treating a ribbon, and a method for manufacturing a magnetic sheet using the manufacturing method. The manufacturing method for obtaining the nanocrystalline alloy ribbon includes a manufacturing method that makes it possible to obtain a nanocrystalline alloy ribbon having excellent magnetic properties such as high saturation magnetic flux density and high magnetic permeability, a manufacturing method that makes it possible to obtain a nanocrystalline alloy ribbon with low magnetostriction, low loss, and isotropy, or a method for manufacturing a nanocrystalline alloy ribbon with reduced wrinkles and streaks and high space factor.

### Means for Solving the Problems

A method for manufacturing a nanocrystalline alloy ribbon according to a first aspect of the present disclosure comprises heating a non-crystalline alloy ribbon by bringing the ribbon into contact with a heating body to produce a nanocrystalline alloy ribbon having a structure in which crystal grains having an average crystal grain size of 50 nm or less are present in an amorphous phase.

The nanocrystalline alloy ribbon is represented by a composition formula: ₐSi_{b}B_{c}Cu_{d}Mₑ, where A is at least one type of Ni and Co, M is at least one type of element selected from a group consisting of Nb, Mo, V, Zr, Hf and W, and in at %, 72.0≤a≤81.0, 9.0≤b≤17.0, 5.0≤c≤10.0, 0.02≤d≤1.2, 0.1≤e≤3.5, and 0≤x≤0.1 are satisfied.

When the non-crystalline alloy ribbon is brought into contact with the heating body and heated, the non-crystalline alloy ribbon is conveyed, and a ribbon holding member comes into contact with a surface of the non-crystalline alloy ribbon opposite to a surface that contacts with the heating body, so that the non-crystalline alloy ribbon is heated while being pressed against the heating body.

The heating body is heated to a heating temperature Ta of Tx1+80° C. or more and Tx1+230° C. or less, where Tx1° C. is a bccFe crystallization starting temperature of the non-crystalline alloy ribbon measured at a heating rate of 20 K/min.

A method for manufacturing a magnetic sheet according to a second aspect of the present disclosure comprises:
preparing a nanocrystalline alloy ribbon obtained by a method for manufacturing a nanocrystalline alloy ribbon according to the first aspect, a support formed in a ribbon shape, and an adhesive layer having an adhesive provided on at least one of a first surface and a second surface of the support; and
continuously guiding the nanocrystalline alloy ribbon and the adhesive layer to an attaching roller to bond the nanocrystalline alloy ribbon and the adhesive layer by the attaching roller.

### Effects of the Invention

According to the present disclosure, a nanocrystalline alloy ribbon having excellent magnetic properties such as high saturation magnetic flux density and high magnetic permeability can be obtained using a method for continuously heat treating a ribbon. Further, a nanocrystalline alloy ribbon with low magnetostriction, low loss, and isotropy can be obtained. Also, a nanocrystalline alloy ribbon with reduced wrinkles and streaks and high space factor can be obtained. In addition, soft magnetic sheets using these nanocrystalline alloy ribbons can be provided.

### BRIEF DESCRIPTION OF THE DRAWINGS

FIG. 1 is a conceptual diagram showing one embodiment of a heat treatment method of the present disclosure.

FIG. 2 is a conceptual diagram showing another embodiment of the heat treatment method of the present disclosure.

FIG. 3 is a conceptual diagram showing another embodiment of the heat treatment method of the present disclosure.

FIG. 4 is a laser microscope photograph showing evaluation of a wrinkle height of Sample No. 10 of the present disclosure.

FIG. 5 is a laser microscope photograph showing evaluation of a wrinkle height of Sample No. 16 of the present disclosure.

FIG. 6 is a laser microscope photograph showing evaluation of a wrinkle height of Sample No. 17 of the present disclosure.

FIG. 7 is a laser microscope photograph showing evaluation of a wrinkle height of Sample No. 18 of the present disclosure.

FIG. 8 is an example temperature profile during heat treatment of the present disclosure.

FIG. 9 is an example temperature profile during the heat treatment of the present disclosure.

FIG. 10 is a schematic diagram for explaining a method for manufacturing a magnetic sheet of the present disclosure.

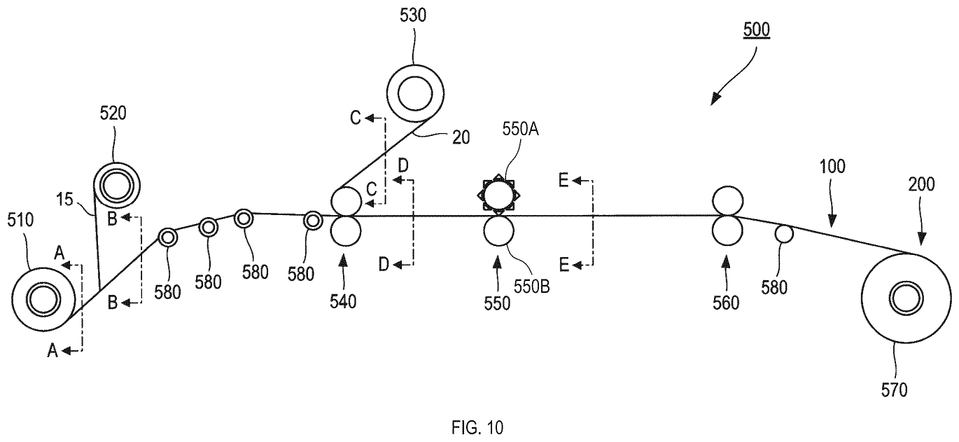

FIG. 11 is a cross-sectional view for explaining a configuration of a laminate supplied from a first unwinding roll.

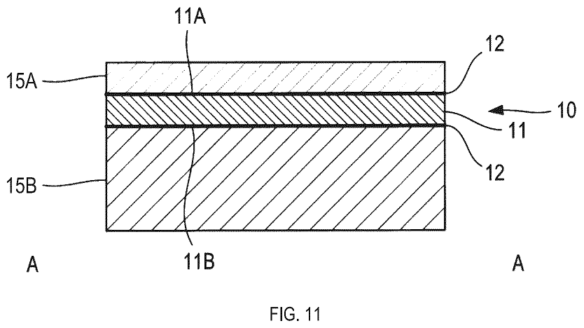

FIG. 12 is a cross-sectional view for explaining a configuration of the laminate supplied from the first unwinding roll and from which a resin sheet has been peeled off.

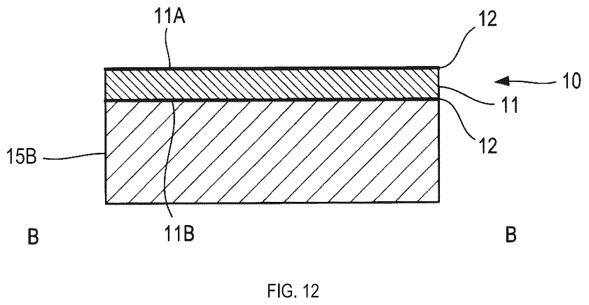

FIG. 13 is a cross-sectional view for explaining a configuration of a nanocrystalline alloy ribbon supplied from a second unwinding roll.

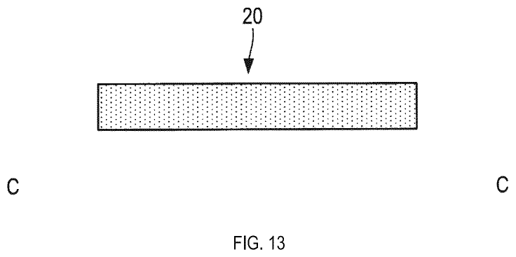

FIG. 14 is a cross-sectional view explaining a state in which the nanocrystalline alloy ribbon is bonded to an adhesive layer by an attaching roller.

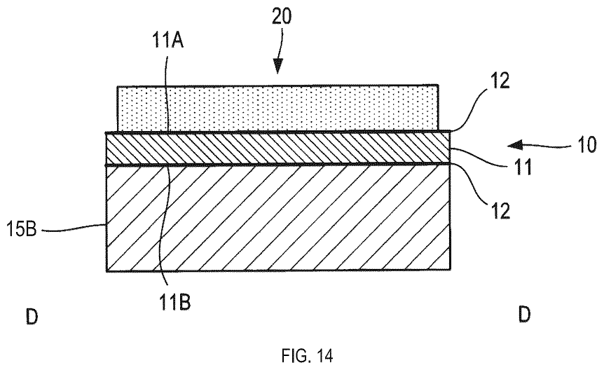

FIG. 15 is a cross-sectional view explaining a state in which cracks are formed in the nanocrystalline alloy ribbon by a crack roller.

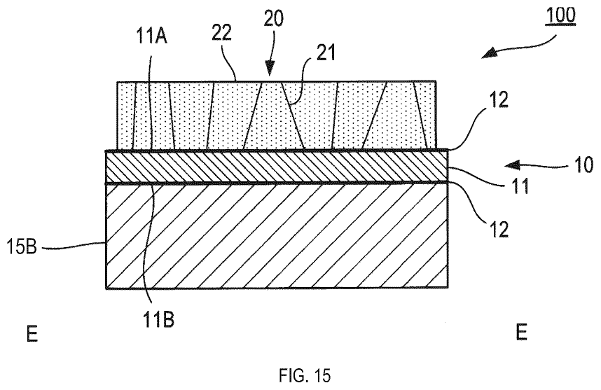

FIG. 16 is a cross-sectional view for explaining a configuration of the magnetic sheet of the present disclosure.

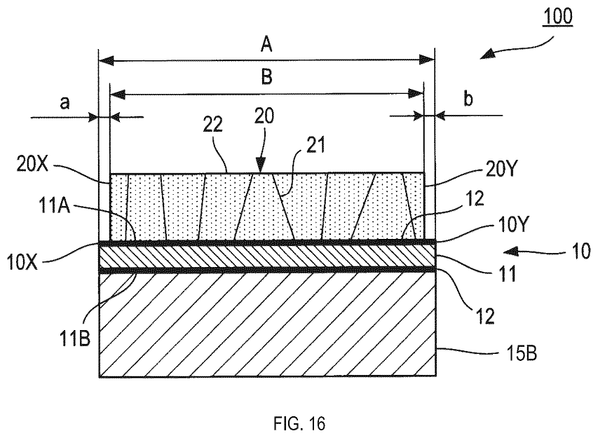

### MODE FOR CARRYING OUT THE INVENTION

Hereinafter, embodiments of the present disclosure will be described in detail. The present disclosure is not limited to the embodiments below, and can be practiced with appropriate modifications within the scope of the spirit of the present disclosure.

In the present disclosure, a range of numerical values expressed with a preposition “to” means that the range includes the numerical values written before and after the preposition “to” as a minimum value and a maximum value, respectively. In the present disclosure, in a set of ranges of numerical values written in stages, the maximum value or the minimum value included in one range of numerical values may be replaced with the maximum value or the minimum value in another range of numerical values written in stages. In the present disclosure, the maximum value or the minimum value of a range of numerical values may be replaced with a value mentioned in the embodiments.

In the present disclosure, a combination of two or more aspects is construed as more preferable aspect.

A nanocrystalline alloy ribbon of the present disclosure is represented by a composition formula: (Fe₁₋ₓAₓ)ₐSi_{b}B_{c}Cu_{d}Mₑ, where A is at least one type of Ni and Co, M is at least one type of element selected from a group consisting of Nb, Mo, V, Zr, Hf and W, and in at %, 72.0≤a≤81.0, 9.0≤b≤17.0, 5.0≤c≤10.0, 0.02≤d≤1.2, 0.1≤e≤3.5, 0≤x≤0.1 are satisfied.

Detailed description of a composition of the nanocrystalline alloy ribbon of the present disclosure will be given below.

A content of Fe (iron) is 72.0% or more and 81.0% or less in at %.

By setting the Fe content to 72.0% or more, high saturation magnetic flux density can be obtained. The Fe content is preferably 73% or more, more preferably 75.0% or more, still more preferably 76% or more, and still more preferably 77% or more. In order to obtain a saturation magnetic flux density of 1.36 T or more, the Fe content is preferably 75.0% or more.

When the Fe content exceeds 81.0%, it becomes difficult to reduce magnetostriction. Therefore, the Fe content is set to 81.0% or less. The Fe content is preferably 80% or less, and more preferably 78% or less.

In addition, a part of Fe may be substituted with at least one type of element selected from Ni and Co. In (Fe₁₋ₓAₓ), A is at least one type of element selected from Ni and Co, and x is 0.1 or less. When a part of Fe is substituted with at least one type of element selected from Ni and Co, a in (Fe₁₋ₓAₓ), falls within a range of 72.0%≤a≤81.0%. A content a in (Fe₁₋ₓAₓ) is preferably 73% or more, more preferably 75.0% or more, still more preferably 76% or more, and still more preferably 77% or more. The content a is preferably 80% or less, and more preferably 78% or less.

A content of Si (silicon) is 9.0% or more and 17.0% or less in at %.

By setting the Si content to 9.0% or more, low magnetostriction can be achieved. The Si content is preferably 10% or more, more preferably 13% or more, and still more preferably 15% or more. If the Si content exceeds 17.0%, then amorphous forming ability decreases, crystallization occurs during casting, and soft magnetic properties significantly deteriorate. The Si content is preferably 16.5% or less.

A content of B (boron) is 5.0% or more and 10.0% or less in at %.

When the B content is less than 5.0, it becomes difficult to form amorphous. Thus, the B content is set to 5.0% or more. The B content is preferably 5.5% or more, and more preferably 6.0% or more.

If the B content exceeds 10.0%, then the Fe content and the Si content decrease. As a result, the saturation magnetic flux density is reduced and the magnetostriction increases. Therefore, the B content is set to 10.0% or less. The B content is preferably 8.5% or less, more preferably 7.5% or less, and still more preferably 7.0% or less.

A content of Cu (copper) is 0.02% or more and 1.2% or less in at %.

Including Cu makes it easier to obtain a uniform, fine nanocrystalline structure. When the Cu content is less than 0.02%, it becomes difficult to achieve an average grain diameter of 50 nm or less. Therefore, the Cu content is set to 0.02% or more. The Cu content is preferably 0.05% or more, more preferably 0.2% or more, still more preferably 0.3% or more, and still more preferably 0.5% or more.

When the Cu content exceeds 1.2%, embrittlement is likely to occur, and the saturation magnetic flux density is reduced. Therefore, the Cu content is set to 1.2% or less. The Cu content is preferably 1.0% or less, more preferably 0.75% or less, and still more preferably 0.65% or less.

The M element is at least one type of element selected from the group consisting of Nb, Mo, V, Zr, Hf and W. A content of M element is 0.1% or more and 3.5% or less in at %.

Including the M element in the nanocrystalline alloy ribbon allows shifting of the deposition starting temperature of the FeB compound, which significantly deteriorates soft magnetic properties, to a higher temperature. This makes it possible to widen the difference between a bccFe (aFc) crystallization starting temperature and the FeB deposition starting temperature, have the effect of widening a range of optimal heat treatment temperatures, and reduce heat treatment conditions. The content of M element is preferably 0.3% or more, and more preferably 0.4% or more.

The M element is expensive. If the content of M element increases, then the price of the nanocrystalline alloy ribbon increases. Thus, it is preferable that the content of M element is small. Accordingly, the content of M element is set to 3.5% or less. The content of M element is preferably 1.5% or less, more preferably 1.0% or less, still more preferably 0.9% or less, still more preferably 0.8% or less, and still more preferably 0.7% or less.

The nanocrystalline alloy ribbon of the present disclosure may contain C (carbon). C has the effect of improving the flow of molten metal, and improves castability when included in a small amount. On the other hand, if a large amount of C is added, the ribbon becomes brittle. Therefore, it is preferable that the C content is 1% by mass or less. In addition, C can be included as an impurity of raw materials. The raw material price increases as the C content decreases. Therefore, it is preferable to allow the C content of 0.01% by mass or more. In order to increase the effect of C, it is preferable that the C content is 0.1% by mass or more.

The nanocrystalline alloy ribbon of the present disclosure may contain impurities other than the aforementioned elements.

Examples of impurities include S (sulfur), O (oxygen), N (nitrogen), Cr, Mn, P, Ti, Al, and so on. For example, a content of S is preferably 200 ppm by mass or less, a content of O is preferably 5000 ppm by mass or less, and a content of N is preferably 1000 ppm by mass or less. A content of P is preferably 2000 ppm by mass or less. It is preferable that the total content of these impurities is 0.5% by mass or less. Furthermore, within the aforementioned range, elements equivalent to impurities may be added.

A method for manufacturing a nanocrystalline alloy ribbon of the present disclosure will be described.

The nanocrystalline alloy ribbon of the present disclosure can be obtained as follows. A molten alloy having the aforementioned alloy composition is ejected onto a rotating cooling roller, and rapidly cooled and solidified on the cooling roller to obtain an alloy ribbon. Then, the alloy ribbon is heat treated to obtain the nanocrystalline alloy ribbon of the present disclosure. The alloy ribbon obtained by rapidly cooling and solidifying the molten alloy has an amorphous alloy structure, and is a non-crystalline alloy ribbon. By heat treating the non-crystalline alloy ribbon, the nanocrystalline alloy ribbon can be obtained. The non-crystalline alloy ribbon obtained by rapidly cooling and solidifying the molten alloy may have a crystalline phase including fine crystals.

In order to obtain the molten alloy, a plurality of materials, that is, element sources (pure iron, ferroboron, ferrosilicon, etc.) to achieve a desired alloy composition are mixed together. The plurality of materials are then heated in an induction heating furnace, and melted to become a molten alloy when the temperature reaches or exceeds the melting point.

The alloy ribbon can be obtained by ejecting the molten alloy from a slit-shaped nozzle having a specified shape onto a rotating cooling roller, and rapidly cooling and solidifying the molten alloy on the cooling roller. The cooling roller may have an outer diameter of 350 to 1000 mm, a width of 100 to 400 mm, and a peripheral speed of rotation of 20 to 35 m/sec. The cooling roller includes an internal cooling mechanism (such as water cooling) for inhibiting an increase in temperature at its outer circumferential portion.

The outer circumferential portion of the cooling roller is preferably made of a Cu alloy having a thermal conductivity of 120 W/(m·K) or more. By setting the thermal conductivity of the outer circumferential portion to 120 W/(m·K) or more, the cooling rate when the molten alloy is cast into an alloy ribbon can be increased. This makes it possible to inhibit embrittlement of the alloy ribbon, thicken the alloy ribbon (increase the thickness), and inhibit surface crystallization during casting. Accordingly, it is possible to inhibit coarsening of crystal grains during heat treatment, and reduce iron loss.

The thermal conductivity of the outer circumferential portion of the cooling roller is preferably 150 W/(m·K) or more, and more preferably 180 W/(m·K) or more.

The outer circumferential portion of the cooling roller indicates a portion where the molten alloy may contact. The outer circumferential portion may have a thickness of around 5 to 15 mm, and the inside thereof may be made of a structural material that maintains a roller structure.

By heat treating the non-crystalline alloy ribbon produced by the aforementioned rapid quenching method (a method for obtaining an alloy ribbon by rapidly cooling a molten alloy), the nanocrystalline alloy ribbon is obtained. The method for manufacturing a nanocrystalline alloy ribbon of the present disclosure is characterized by the heat treatment method.

The heat treatment method of the present disclosure is a method in which a non-crystalline alloy ribbon is brought into contact with a heating body and heated. When the non-crystalline alloy ribbon is brought into contact with the heating body and heated, the non-crystalline alloy ribbon is conveyed and heated while being pressed against the heating body by a ribbon holding member that contacts a side of the non-crystalline alloy ribbon opposite to a side that contacts the heating body.

In the present disclosure, the heating body is heated to a heating temperature Ta of Tx1+80° C. or more and Tx1+230° C. or less, where Tx1° C. is a bccFe crystallization starting temperature of the non-crystalline alloy ribbon measured at a heating rate of 20 K/min. Preferably, the heating body is heated to Tx1+100° C. or more. When the non-crystalline alloy ribbon is heated, it is preferable that the heating rate of the non-crystalline alloy ribbon is 15000° C./min. or more.

In the heat treatment of the present disclosure, contact time (retention time) between the non-crystalline alloy ribbon and the heating body is preferably 0.1 seconds or more and 30 seconds or less.

During the heat treatment, it is possible to adjust properties such as magnetic permeability and B80_{L}/B80_{W} by applying a magnetic field or tension to the non-crystalline alloy ribbon.

In the present disclosure, a flexible member may be used as the ribbon holding member, so that the non-crystalline alloy ribbon is pressed against the heating body.

It is preferable that the flexible member is a metal member. The flexible member is a member that can be deformed along the roller. The ribbon holding member may be a belt or a roller.

An example of the heat treatment method of the present disclosure will be described with reference to the drawings.

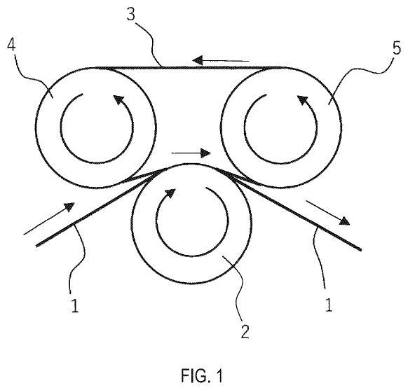

FIG. 1 is a conceptual diagram showing one embodiment of the heat treatment method of the present disclosure.

A configuration used in the heat treatment method shown in FIG. 1 includes a heating roller 2 serving as a heating body, a ribbon holding metal belt 3 (ribbon holding member), and rollers 4, 5 supporting the ribbon holding metal belt 3. The ribbon holding metal belt 3 is an example configuration that brings a non-crystalline alloy ribbon (hereinafter, also referred to as a ribbon) 1 into a state pressed against the heating roller 2 serving as a heating body.

In the heat treatment method, the non-crystalline alloy ribbon 1 is passed between the heating roller 2 (heating body) and the ribbon holding metal belt 3, and the ribbon 1 is heated while being pressed against the heating body (heating roller 2). Each arrow in FIG. 1 indicates movement of the corresponding portion. The heating roller 2 and the rollers 4, 5 are cylindrical, and have a rotating structure. By these rollers, the non-crystalline alloy ribbon 1 is heated while being conveyed and pressed against the heating roller 2.

The ribbon 1 after heated by the heating roller 2 becomes a nanocrystalline alloy ribbon.

It is preferable that heating rollers that can be heated are used as the rollers 4, 5. It is preferable that the ribbon holding metal belt 3 is heated by these rollers before contacting the ribbon 1. When the rollers 4, 5 are heating rollers, it is preferable that a temperature of the ribbon holding metal belt 3 (temperature when the ribbon holding metal belt 3 is bought into contact with the ribbon 1) is set to be equal to, or slightly lower than, the heating temperature of the ribbon 1. Temperatures of the rollers 4, 5 may be set to temperatures that make the temperature of the ribbon holding metal belt 3 appropriate. For example, it is also desirable that the temperatures of the rollers 4, 5 are set to be approximately 50° C. higher than the temperature of the heating body. For the temperatures of the ribbon holding metal belt 3 and the rollers 4, 5, temperatures suitable for heat treatment of the ribbon 1 can be selected.

The ribbon holding metal belt 3 is an example of a flexible member, and the flexible member is preferably a metal member from the viewpoint of flexibility and strength. For example, it is more preferable to use a material excellent in heat resistance such as heat-resistant stainless steel and nickel-based super heat-resistant alloy.

According to the aforementioned heat treatment method, the flexible member (ribbon holding metal belt 3) is pressed against the surface of the non-crystalline alloy ribbon 1 opposite to the surface that contacts the heating body. As a result, the non-crystalline alloy ribbon 1 is pressed against the heating body (heating roller 2). It is preferable that the non-crystalline alloy ribbon 1 is in close contact with the heating roller 2 by the ribbon holding metal belt 3, and the non-crystalline alloy ribbon 1, the ribbon holding metal belt 3, and the heating roller 2 move as one.

The heating roller 2 is a heating body (heating body of the present disclosure) for directly contacting and heating the non-crystalline alloy ribbon 1. The non-crystalline alloy ribbon 1 is brought into contact with a part of an outer peripheral surface (a part of the circumferential region) of the cylindrical heating roller 2, and heated. The heating roller 2 may have a driving force to convey the non-crystalline alloy ribbon. Both of the rollers 4, 5 or only one of the rollers 4, 5 may be used as rollers or a roller for driving the ribbon holding metal belt 3. The roller 5 may be provided with a driving force, and the roller 4 may be mechanically subordinate to the roller 5. In this way, complex control such as electrically synchronous operation of the rollers 4 and 5 can be avoided. Furthermore, correction of synchronization errors between the roller 4 and the roller 5 due to differences in thermal expansion between the roller 4 and the roller 5 becomes unnecessary.

The heating roller 2 is an example of a heating body having a convex surface which the non-crystalline alloy ribbon 1 contacts to be heated. Also, the term “convex surface” means a raised surface toward the non-crystalline alloy ribbon 1 side. For example, the heating roller 2, like the roller shown in FIG. 1, may have a curved surface formed by a cylindrical (columnar) side surface, or a curved surface formed as a part of a member, such as a curved surface portion of an approximately D-shaped member. The heating roller 2 may have any shape that allows the non-crystalline alloy ribbon to follow and ensures sufficient contact. The heating body of the present disclosure may be configured not to rotate, and may be configured such that the ribbon moves (slides) on the heating body.

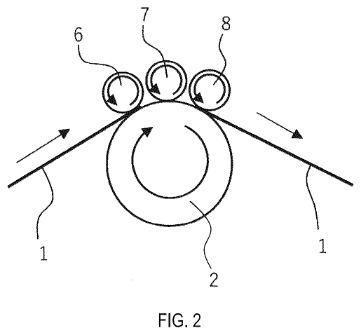

FIG. 2 is a conceptual diagram showing another embodiment of the heat treatment method of the present disclosure.

A configuration used in the heat treatment method shown in FIG. 2 includes a heating roller 2 serving as a heating body, and ribbon holding rollers 6, 7, 8. The ribbon holding rollers 6, 7, 8 function as a ribbon holding member that brings the non-crystalline alloy ribbon 1 into a state pressed against the heating roller 2. In the heat treatment method shown in FIG. 2, the ribbon 1 is passed between the heating roller 2 (heating body) and the ribbon holding rollers 6, 7, 8, and heated while being pressed against the heating body (heating roller 2). Each arrow in FIG. 2 indicates movement of the corresponding portion. The heating roller 2 and the ribbon holding rollers 6, 7, 8 are cylindrical, and have a rotating structure. By these rollers, the non-crystalline alloy ribbon 1 is heated while being conveyed and pressed against the heating roller 2. It is preferable that heating rollers that can be heated are used as the ribbon holding rollers 6, 7, 8.

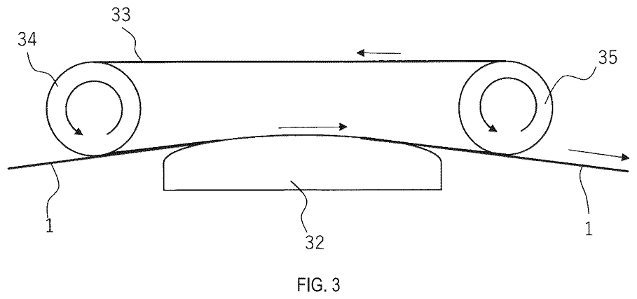

FIG. 3 is a conceptual diagram showing another embodiment of the heat treatment method of the present disclosure.

A configuration used in the heat treatment method shown in FIG. 3 includes an approximately D-shaped heating body 32 in place of the heating roller 2 in FIG. 1, and as a configuration that brings the non-crystalline alloy ribbon 1 into a state pressed against the heating body 32, includes a ribbon holding metal belt 33 and rollers 34, 35 that support the ribbon holding metal belt 33. In the heat treatment method shown in FIG. 3, the ribbon 1 is passed between the heating body 32 and the ribbon holding metal belt 33 (ribbon holding member), and heated while being pressed against the heating body 32. Each arrow in FIG. 3 indicates movement of the corresponding portion. The rollers 34, 35 are cylindrical, and have a rotating structure. As a result, the non-crystalline alloy ribbon 1 is heated while being conveyed and pressed against the heating roller 2. The non-crystalline alloy ribbon 1 slides on the heating body 32. It is preferable that heating rollers that can be heated are also used as the rollers 34, 35. It is preferable that the ribbon holding metal belt 33 is heated by these rollers.

As shown in FIGS. 1, 2 and 3, when the non-crystalline alloy ribbon is brought into contact with the heating body and heated, it is possible to heat the non-crystalline alloy ribbon 1 while being conveyed and pressed against the heating body by the ribbon holding member.

At this time, it is preferable that a heating rate of the non-crystalline alloy ribbon 1 is set to 15000° C./min. or more. In addition, it is more preferable that the heating rate of the non-crystalline alloy ribbon 1 is set to 30000° C./min. or more.

In order to obtain a nanocrystalline alloy ribbon by heat treatment, a heating rate appropriate to achieve a fine nanocrystalline structure varies depending on the composition. For example, the lower the Cu (lower the Cu content), the lower the M element (lower the M element content), and the higher the Fe (higher the Fe content) of the non-crystalline alloy ribbon 1, which allows higher saturation magnetic flux density to be obtained, the faster heating rate is required. In case of the composition of the present disclosure, a lower limit of the heating rate is set to 15000° C./min., and an upper limit can be determined by installation capacity of a heat treatment device, temperatures of the heating body and the ribbon holding member, and a contact state between the heating body and ribbon holding member and the ribbon. However, the practical upper limit of the heating rate is around 240000° C./min. The heating rate is preferably 100000° C./min.

It is preferable that the heating body has a width greater than a width of the non-crystalline alloy ribbon 1. As a result, when the non-crystalline alloy ribbon 1 is pressed against the heating body, the entire width of the ribbon 1 is in close contact with the heating body. It is also preferable that the ribbon holding member has a width greater than the width of the non-crystalline alloy ribbon 1. This makes it easier for the entire width of the non-crystalline alloy ribbon 1 to come into close contact with the heating body when the ribbon 1 is pressed against the heating body. A direction in which the non-crystalline alloy ribbon 1 is conveyed is referred to as a longitudinal direction, and a length of the longitudinal direction is simply referred to as the length. Also, a direction orthogonal to the longitudinal direction is referred to as a width direction, and a length of the width direction is referred to as the width.

In addition, when the non-crystalline alloy ribbon 1 is heated while being pressed against the heating body, a distance from when the non-crystalline alloy ribbon 1 comes into contact with the heating body until the ribbon 1 is separated is preferably 50 mm or more in the length of the heating body surface. Furthermore, the distance from when the non-crystalline alloy ribbon comes into contact with the heating body until the ribbon 1 is separated is more preferably 150 mm or more in the length of the heating body surface.

A conveying speed of the non-crystalline alloy ribbon 1 is preferably 1 m/min. or more. Upon mass production of the nanocrystalline alloy ribbon, the faster the conveying speed, the higher the production volume. Therefore, it is more preferable that the conveying speed is 10 m/min. or more.

Contact time during which the non-crystalline alloy ribbon 1 is in contact with the heating body is preferably 0.1 seconds to 30 seconds. A lower limit of the contact time is more preferably 0.2 seconds. An upper limit of the contact time is more preferably 10 seconds, still more preferably 5 seconds, and most preferably 2 seconds. In case of increasing speed and stabilization to improve mass productivity, it is preferable that the contact time is set within a range of 0.2 seconds to 2 seconds.

According to the heat treatment method of the present disclosure, by pressing the non-crystalline alloy ribbon 1 against the heating body, the heating body and the ribbon 1 are brought into good contact with each other, heat transfer from the heating body to the ribbon 1 is improved, and the heating rate of the ribbon 1 becomes faster. In addition, it becomes possible to dissipate more heat generated by crystallization to the heating body and the ribbon holding member (belt or roller). Therefore, it is possible to reduce maximum temperature of the ribbon 1 (inhibit temperature increase due to self-heating). Further, the ribbon 1 can be held down by the ribbon holding member (belt or roller), and thus wrinkles or streaks that may be generated during crystallization can be reduced. As a result, heat treatment at higher temperature becomes possible, and heat treatment with higher heating rate and shorter contact time becomes possible. Accordingly, productivity can be improved and a uniform nanocrystalline structure can be obtained. A nanocrystalline alloy ribbon having excellent magnetic properties such as higher saturation magnetic flux density can be obtained.

### [Heating Rate of Non-Crystalline Alloy Ribbon During Heat Treatment]

The inventors confirmed the heating rate of the non-crystalline alloy ribbon during heat treatment using the following method.

A surface temperature of the non-crystalline alloy ribbon was measured using a radiation thermometer FLHX-TNE0090 manufactured by JAPANSENSOR Corporation. Because this radiation thermometer can only measure fixed points, temperature of the non-crystalline alloy ribbon 1 during heat treatment was measured without the ribbon 1 being conveyed. In the method shown in FIG. 3, the ribbon holding metal belt 33 is not driven, the ribbon 1 was disposed between the ribbon holding metal belt 33 and the heating body 32, and tension was applied to the ribbon holding metal belt 33, so that the ribbon 1 was pressed against the heating body 32. The heating body 32 was configured as a mechanism that ascends and descends, and was lowered and heated without contacting the ribbon 1. Then, after the heating body 32 reached a specific heat treatment temperature, the heating body 32 is raised, the metal belt 33 pressed the ribbon 1 toward the heating body 32 side, and the temperature of the ribbon 1 was measured. This confirmed temperature change after the ribbon 1 was pressed against the heating body.

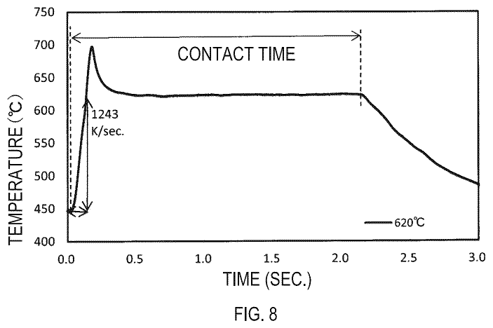

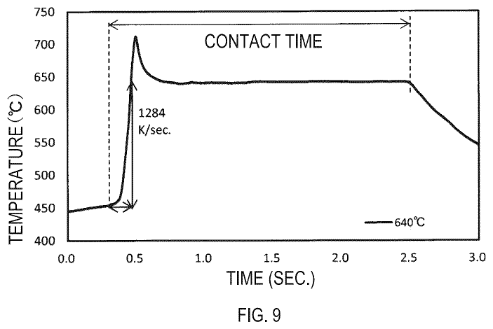

FIG. 8 shows an example temperature profile measured when the temperature of the heating body 32 is 620° C., and FIG. 9 shows an example temperature profile measured when the temperature of the heating body 32 is 640° C. An X-axis indicates time (second), and a Y-axis indicates the temperature of the ribbon 1 measured. Using the aforementioned method, the measurement was performed by pressing the ribbon 1 against the heating body 32 heated to a set temperature (620° C., 640° C.). Contact time shown by an arrow parallel to the X-axis in FIGS. 8 and 9 is time during which the ribbon 1 was pressed against the heating body 32. According to this measurement method, the temperature of the ribbon 1 increases to around 450° C. before contacting the heating body 32. Thus, the heating rate is shown by an arrow parallel to the Y-axis in FIGS. 8 and 9. The heating rate was calculated as a value obtained by dividing the temperature change from when the ribbon 1 contacts the heating body 32 until the temperature reached the set temperature by the time. The temperature of the ribbon 1 was measured by making a measurement hole in the ribbon holding metal belt 33. When the ribbon 1 is actually heat treated, the ribbon 1 is pressed by the metal belt 33, so it can be assumed that the heating rate is faster than the heat rates in FIGS. 8 and 9. However, because actual measurement is not possible, the heating rate under each condition has not been measured. Nonetheless, it was found from FIGS. 8 and 9 that the heating rate at the set temperature of 620° C. was 1240° C./sec. (74400° C./min.) and the heating rate at 640° C. was 1280° C./sec. (76800° C./min.). From these, it was confirmed that the heating rate became 15000° C./min. or more.

Next, a pressure to press the non-crystalline alloy ribbon 1 against the heating body is preferably 0.03 MPa or more, more preferably 0.05 MPa or more, and still more preferably 0.07 MPa or more.

In order to further improve the contact state between the non-crystalline alloy ribbon 1 and the heating body, it is also effective to provide the heating body with curvature. The heating body preferably has a curvature radius of 25 mm or more.

In order to increase the heating rate during heating of the non-crystalline alloy ribbon 1, it is also effective to heat the ribbon holding member (belt or roller) to the same temperature as that of the heating body, and heat the ribbon 1 from both sides. In FIGS. 1, 2 and 3, heating rollers are used as the rollers 4, 5, 6, 7, 8, 34 and 35. In order to inhibit heat generation due to bccFe crystallization in the ribbon, it is also effective to set the temperatures of the belt or roller lower than the heating temperature Ta° C.

According to the present disclosure, a nanocrystalline alloy ribbon having excellent magnetic properties and isotropy can be obtained. Furthermore, a nanocrystalline alloy ribbon with reduced wrinkles or streaks that achieves high space factor can be obtained.

The nanocrystalline alloy ribbon of the present disclosure has a saturation magnetic flux density Bs of 1.15 T or more, preferably 1.20 T or more, still more preferably 1.35 T or more, still more preferably 1.36 T or more, still more preferably 1.37 T or more, and still more preferably 1.40 T or more.

Moreover, the nanocrystalline alloy ribbon of the present disclosure preferably has a ratio Br/B₈₀₀₀ of a residual magnetic flux density Br and a magnetic flux density B₈₀₀₀ in a magnetic field of 8000 A/m of 0.20 or more. In addition, the maximum magnetic permeability is preferably 4000 or more. Furthermore, the maximum magnetic permeability is preferably 5000 or more.

It is preferable that the nanocrystalline alloy ribbon of the present disclosure has a ratio (B80_{L}/B80_{W}) of the magnetic flux density B80_{L} when the magnetic field of 80 A/m is applied in a longitudinal direction of the nanocrystalline alloy ribbon to the magnetic flux density B80_{W} when the magnetic field of 80 A/m is applied in a width direction orthogonal to the longitudinal direction, of 0.60 to 1.40, and that both B80_{L} and B80_{W} are 0.4 T or more. The ratio (B80_{L}/B80_{W}) is more preferably 0.70 to 1.30. Also, both B80_{L} and B80_{W} are more preferably 0.5 T or more.

The nanocrystalline alloy ribbon of the present disclosure preferably has a space factor of 68.0% or more, more preferably 70% or more, and still more preferably 75% or more.

The space factor can be measured by the following method compliant with JIS C 2534:2017.

Twenty sheets of ribbons cut into a length of 120 mm are stacked on a flat sample stage, and a flat anvil having a diameter of 16 mm is placed on the stacked ribbons with a pressure of 50 kPa. Then, the height is measured at 10 mm intervals in the width direction. The maximum height at the time is set to hmax (μm) and a space factor LF is calculated using the following formula.

LF (%)=sample weight (g)/density (g/cm³)/hmax (μm)/sample length (240 cm)/ribbon width (cm)×10000

In this case, density (g/cm³) is a density of the alloy ribbon after the heat treatment. The density can be 7.4 g/cm³.

When the non-crystalline alloy ribbon 1 is brought into contact with the heating body and heated to turn the non-crystalline alloy ribbon 1 into a nanocrystalline alloy ribbon, local differences occur in the heating rate or temperature of the non-crystalline alloy ribbon 1 due to variations in contact between the non-crystalline alloy ribbon 1 and the heating body. In this case, differences also occur in how crystallization progresses. This causes local distortion, causing a problem in which a portion of the ribbon 1 is lifted from the heating body. In the lifted portion, it becomes difficult to dissipate self-heating due to crystallization to the heating body, and the temperature of the ribbon 1 rapidly rises, reaching a FeB deposition temperature, which makes wrinkles or streaks more likely to occur. As a result, the space factor is reduced. In addition, since the wrinkled or streaked portions become very brittle, problems in handling such as cracking of the nanocrystalline alloy ribbon during conveyance or stacking, and deterioration of the magnetic properties may occur.

According to the present disclosure, the non-crystalline alloy ribbon 1 is pressed against the heating body by the ribbon holding member that contacts the surface of the non-crystalline alloy ribbon 1 opposite to the surface that contacts the heating body. Thus, the non-crystalline alloy ribbon 1 can be heated evenly, and the alloy ribbon can be inhibited from being lifted, thereby inhibiting generation of wrinkles or streaks. Furthermore, the present disclosure has the effect of correcting wrinkles generated during casting of the non-crystalline alloy ribbon 1 due to variations in cooling. According to the present disclosure, wrinkles or streaks are reduced, and a nanocrystalline alloy ribbon with excellent flatness can be obtained.

The nanocrystalline alloy ribbon of the present disclosure preferably has a wrinkle height of 0.15 mm or less, more preferably 0.10 mm or less, and still more preferably 0.08 mm or less. The wrinkle height refers to heights of wrinkles or streaks, which can be evaluated by a method explained in the examples below.

The nanocrystalline alloy ribbon of the present disclosure preferably has a thickness of 25 μm or less, and more preferably 20 μm or less. In addition, the thickness is preferably 5 μm or more, and more preferably 10 μm or more. Its width is preferably 5 mm or more, more preferably 20 mm or more, and still more preferably 30 mm or more.

If the nanocrystalline alloy ribbon of the present disclosure is too wide, then stable production becomes difficult. Thus, the width is preferably 500 mm or less, and more preferably 400 mm or less.

By using the nanocrystalline alloy ribbon of the present disclosure in magnetic cores and magnetic shielding materials for use in electronic components, motors, and the like, magnetic cores and magnetic shielding materials with excellent properties can be obtained.

The nanocrystalline alloy ribbon of the present disclosure, for example, can form a magnetic sheet that can be used as a magnetic sheet for contactless charging.

### Example 1

In Example 1, element sources were mixed so that the alloy composition was Fe_{76.4}Si₁₁₆B_{6.5}Cu_{0.6}Nb_{0.5}, the mixture was heated to 1350° C. to prepare a molten alloy, and the molten alloy was ejected onto a cooling roller having an outer diameter of 400 mm and a width of 200 mm that rotates at a peripheral speed of 30 m/s. The molten alloy was rapidly cooled and solidified on the cooling roller to prepare a non-crystalline alloy ribbon. The outer circumferential portion of the cooling roller is made of a Cu alloy having a thermal conductivity of 150 W/(m·K), and includes an internal cooling mechanism for controlling the temperature of the outer circumferential portion.

This non-crystalline alloy ribbon was heat treated under conditions of a heating rate of 6° C./min., a heat treatment temperature of 470° C., and retention time of 1 hour to prepare a sample (Reference Example 1), and was heat treated under conditions of a heating rate of 79200° C./min., a heat treatment temperature of 660° C., and retention time of 1.2 seconds to prepare a sample (Example 1). In the heat treatment of Example 1, a heat treatment method shown in FIG. 1 was used. The samples of Example 1 and Reference Example 1 after the heat treatment were nanocrystalline alloy ribbons. The heat treatment temperature of Example 1 is a heating temperature of the heating body. In addition, Tx1 of this alloy composition (the same as that of No. 10 in Table 2) was 468.5° C. The heating temperature Ta of the heating body of Example 1 was Tx1+191.5° C.

The nanocrystalline alloy ribbons of Example 1 and Reference Example 1 had a width of 50 mm and a thickness of 16.4 sm.

Table 1 shows the average crystal grain size, the iron loss at 20 kHz and 0.2 T, Br/B₈₀₀₀, and the maximum magnetic permeability for Example 1 and Reference Example 1. B₃₀₀₀ (Bs) of Example 1 and Reference Example 1 were equivalent to 1.41 T. In Example 1, by setting the heating rate to 15000° C./min. or more, it was possible to have the average crystal grain size of 50 nm or less. The iron loss at 20 kHz and 0.2 T was 10 W/kg or less, which was also excellent. Br/B₈₀₀₀ was 0.20 or more, and the maximum magnetic permeability indicated 4000 or more. In Example 1, a nanocrystalline alloy ribbon having high saturation magnetic flux density, low loss, and high magnetic permeability was achieved. The measurement method will be described in Example 2.

TABLE 1

| | | Heat | | | Average | Iron loss | | |
|---|---|---|---|---|---|---|---|---|
| | Heating | treatment | | | crystal grain | 20 kHz, | | Maximum |
| | rate | temp. | Retention | | size | 0.2 T | Br/B₈₀₀₀ | magnetic |
| | ° C./min. | ° C. | time | | nm | W/kg | (Br/Bs) | permeability |
| Example 1 | 79200 | 660 | 1.2 | sec. | 30.9 | 7.5 | 0.47 | 20400 |
| Ref. Ex. 1 | 6 | 470 | 20 | min. | 83.4 | 30.5 | 0.87 | 12000 |

### Example 21

In Example 2, element sources were mixed so as to obtain each composition shown in Table 2. The mixture was heated to 1350° C. to prepare a molten alloy. The molten alloy was ejected onto a cooling roller having an outer diameter of 400 mm and a width of 200 mm that rotated at a peripheral speed of 30 m/sec., and was rapidly cooled and solidified on the cooling roller to prepare a non-crystalline alloy ribbon. Table 3 shows the width and thickness of the non-crystalline alloy ribbons. An outer circumferential portion of the cooling roller was made of a Cu alloy having a thermal conductivity of 150 W/(m·K), and includes an internal cooling mechanism for controlling the temperature of the outer circumferential portion.

Heat treatment was performed using the non-crystalline alloy ribbons made of materials shown in Table 2, under the conditions (heating rate, heating temperature of the heating body, pressure to press the non-crystalline alloy ribbon against the heating body: pressing pressure, retention time) shown in Table 3. The evaluation results are shown in Tables 3 and 4. Blank fields in the tables mean that no measurement was performed.

TABLE 2

| | Composition (at %) | | | | |
|---|---|---|---|---|---|
| No. | Fe | Si | B | Cu | Nb |
| 1 | 75.7 | 15.3 | 7.0 | 1.0 | 1.0 |
| 2 | 77.3 | 12.0 | 9.0 | 0.7 | 1.0 |
| 3 | 79.9 | 9.5 | 9.0 | 0.7 | 1.0 |
| 4 | 76.8 | 14.0 | 8.0 | 0.7 | 0.5 |
| 5 | 75.9 | 15.5 | 7.0 | 0.8 | 0.8 |
| 6 | 76.9 | 14.2 | 7.8 | 0.7 | 0.4 |
| 7 | 76.9 | 16.0 | 6.0 | 0.6 | 0.5 |
| 8 | 76.0 | 16.0 | 6.0 | 1.0 | 1.0 |
| 9 | 76.4 | 16.0 | 6.0 | 0.6 | 1.0 |
| 10 | 76.4 | 16.0 | 6.5 | 0.6 | 0.5 |
| 11 | 76.8 | 16.0 | 6.5 | 0.3 | 0.4 |
| 12 | 73.6 | 15.3 | 7.1 | 1.0 | 3.0 |
| 13 | 76.4 | 16.1 | 6.0 | 0.05 | 1.5 |
| 14 | 76.4 | 16.6 | 6.0 | 0.05 | 1.0 |

TABLE 3

| | | | | | | | | Average | | Saturation | |
|---|---|---|---|---|---|---|---|---|---|---|---|
| | | | | | | | | crystal | | magnetic | |
| | | | | Heating | Heating | Pressing | Retention | grain | Volume | flux | Maximum |
| | Width | Thickness | T × 1 | rate | temp. | pressure | time | size | fraction | density | magnetic |
| No. | mm | μm | ° C. | ° C./min. | ° C. | MPa | sec. | nm | % | T | permeability |
| 1 | 33 | 14.6 | 470.9 | 74400 | 620 | 0.115 | 0.6 | 27.3 | 92.6 | 1.40 | 10100 |
| 2 | 33 | 16.5 | 477.9 | 79200 | 660 | 0.115 | 1.2 | 29.0 | 67.5 | 1.47 | 5173 |
| 3 | 33 | 16.0 | 441.2 | 76800 | 640 | 0.115 | 1.2 | 30.6 | 77.8 | 1.59 | 10323 |
| 4 | 33 | 15.4 | 469.3 | 78000 | 660 | 0.115 | 0.6 | 35.1 | 81.8 | 1.48 | 7800 |
| 5 | 50 | 15.1 | 479.0 | 79200 | 660 | 0.115 | 1.8 | 28.4 | 86.6 | 1.37 | 5600 |
| 6 | 50 | 16.5 | 472.8 | 79200 | 660 | 0.115 | 1.2 | 34.9 | 81.9 | 1.45 | 9900 |
| 7 | 33 | 16.1 | 462.7 | 76800 | 640 | 0.115 | 0.4 | 27.9 | 87.7 | 1.42 | 12264 |
| 8 | 25 | 15.3 | 474.0 | 74400 | 620 | 0.115 | 0.9 | 26.7 | 87.8 | 1.37 | 22549 |
| 9 | 50 | 15.9 | 473.0 | 74400 | 620 | 0.115 | 0.6 | 27.4 | 87.4 | 1.38 | 10448 |
| 10 | 50 | 16.4 | 468.5 | 79200 | 660 | 0.115 | 1.2 | 30.9 | 87.5 | 1.41 | 20400 |
| 11 | 50 | 16.0 | 510.1 | 79200 | 660 | 0.115 | 1.2 | 32.3 | 85.2 | 1.42 | 19505 |
| 12 | 30 | 16 | 519.3 | 79200 | 660 | 0.115 | 1.2 | 19.8 | 57.5 | 1.23 | 22454 |
| 13 | 25 | 16.6 | 505.9 | 81600 | 680 | 0.115 | 0.4 | 27.7 | 87.8 | 1.37 | 52965 |
| 14 | 25 | 17.3 | 475.1 | 76800 | 640 | 0.115 | 0.6 | 25.8 | 91.0 | 1.39 | 53799 |

### [Average Crystal Grain Size]

TABLE 4

| | | | | Iron loss | | | | |
|---|---|---|---|---|---|---|---|---|
| | | | | 20 kHz, | | Saturation | Wrinkle | Space |
| | | | | 0.2 T | Br/B8000 | magnetostriction | height | factor |
| No. | B80_{L} | B80_{W} | B80_{L}/B80_{W} | W/kg | (Br/Bs) | ppm | mm | % |
| 1 | 0.64 | 0.62 | 1.02 | | 0.24 | 1.1 | 0.051 | 79.8 |
| 2 | 0.52 | 0.42 | 1.24 | | 0.24 | 5.9 | 0.047 | 79.6 |
| 3 | 0.74 | 0.88 | 0.84 | | 0.56 | 7.9 | 0.066 | 79.4 |
| 4 | 0.87 | 0.96 | 0.91 | 7.8 | 0.29 | 4.4 | 0.031 | 74.2 |
| 5 | 0.77 | 0.87 | 0.89 | | 0.22 | 3.2 | 0.047 | 72.1 |
| 6 | 0.76 | 0.66 | 1.14 | | 0.30 | 4.7 | 0.031 | 73.3 |
| 7 | 0.84 | 0.76 | 1.11 | | 0.26 | 2.8 | 0.029 | 76.7 |
| 8 | 0.68 | 0.55 | 1.23 | | 0.24 | 0.5 | 0.046 | 75.4 |
| 9 | 0.66 | 0.59 | 1.13 | 7.8 | 0.21 | 1.7 | 0.035 | 71.4 |
| 10 | 0.93 | 0.91 | 1.03 | 7.5 | 0.47 | 3.0 | 0.025 | 70.2 |
| 11 | 1.15 | 1.04 | 1.11 | | 0.35 | 3.1 | 0.051 | 70.5 |
| 12 | 0.67 | 0.48 | 1.40 | | 0.24 | 0.8 | 0.034 | 75.0 |
| 13 | 0.81 | 0.62 | 1.31 | | 0.33 | −0.4 | 0.055 | 74.8 |
| 14 | 0.73 | 0.57 | 1.28 | | 0.30 | 0 | 0.126 | 72.6 |

The average crystal grain size was determined from the Scherrer formula using the integral width of the diffraction peak from the (110) plane in the X-ray diffraction pattern obtained from the X-ray diffraction experiment. The integral width of the diffraction peak from the (110) plane is determined by peak resolution using a pseudo-Voigt function for the diffraction pattern. If the average grain diameter is D, the integral width is β, the diffraction angle is 0, the Scherrer constant is K, and the wavelength of X-rays is λ, then D can be determined from the Scherrer formula (Formula 1) given below. In this case, however, it was assumed that the wavelength of X-rays λ=0.154050 nm, and the Scherrer constant K=1.333.

The integral width was corrected to be narrowed by the amount of the diffraction line width due to the device.

$$D = \frac{K λ}{β cos θ} \qquad [ Formula 1 ]$$

### [Volume Fraction]

The volume fraction is a volume fraction of nanocrystals, and the portion other than the nanocrystals is a non-crystalline portion.

The volume fraction is determined as a ratio of the integral intensity of the diffraction peak from the (110) plane of Fe to the integral intensity of the halo pattern. The integral intensity of the halo pattern is integral intensity of the diffraction peak from the (110) plane of Fe plus the integral intensity near 20=44°. The integral intensities of the peak exhibited by the nanocrystals and the halo pattern exhibited by the amorphous are determined by peak resolution using a pseudo-Voigt function for the X-ray diffraction pattern. The volume fraction V is determined from a formula (Formula 2) below where Ic is the integral intensity of the (110) peak of nanocrystals, and Ia is the integral intensity of the halo pattern near 20=44°. In a case of the composition of the present example, however, the peaks of the integral intensities of Fe and Fe₂B overlap, and are difficult to separate. Thus, Ic and Ia may include the integral intensities of deposited Fe₂B, albeit in a small amount.

$$V = \frac{Ic}{Ic + Ia} \times 100 \qquad [ Formula 2 ]$$

### [Saturation Magnetic Flux Density Bs]

The saturation magnetic flux density Bs is obtained by applying a magnetic field of 8000 A/m to a heat treated nanocrystalline alloy ribbon (single sheet sample) using a DC magnetization characteristics test equipment manufactured by Metron Giken Co., Ltd., and measuring the maximum magnetic flux density at that time. The nanocrystalline alloy ribbon of the present disclosure has a property of being relatively easy to saturate, and thus saturates when a magnetic field of 8000 A/m is applied. Since B8000 and the saturation magnetic flux density Bs have approximately the same value, the saturation magnetic flux density Bs is represented by B8000.

### [Maximum Magnetic Permeability]

The maximum magnetic permeability was determined by applying a magnetic field of 800 A/m to a heat treated nanocrystalline alloy ribbon (single sheet sample) using a DC magnetization characteristics test equipment manufactured by Metron Giken Co., Ltd., and measuring the magnetic permeability against the magnetic field H at that time. The maximum magnetic permeability at the time is applied.

### [Magnetic Flux Density B80]

A magnetic field of 80 A/m was applied in each of a longitudinal direction (casting direction) of the nanocrystalline alloy ribbon and a width direction orthogonal to the longitudinal direction by a DC magnetization characteristics test equipment manufactured by Metron Giken Co., Ltd., and the respective maximum magnetic flux densities at that time were set to B80_{L} and B80_{W}. Then, a ratio B800/B80_{W} was calculated to evaluate isotropy.

### [Saturation Magnetostriction]

A magnetic field of 5 kOe was applied, using an electromagnet, to a sample (nanocrystalline alloy ribbon) with a strain gauge manufactured by Kyowa Electronic Instruments Co., Ltd. attached thereto. Then, the electromagnet was rotated 360°, and the maximum change in elongation and contraction of the sample caused when the direction of the magnetic field applied to the sample was changed 360° was measured from the change in electrical resistance value of the strain gauge. Saturation magnetostriction=⅔×maximum change.

### [Wrinkle Height]

The wrinkle height refers to a height of streaks and wrinkles formed on a ribbon surface. The nanocrystalline alloy ribbon was interposed between glass plates, and a height of the ribbon surface was measured by a laser microscope VR3200 manufactured by Keyence Corporation. The difference between the maximum value and the minimum value was calculated as the wrinkle height. The crystalline alloy ribbon was interposed between glass plates, because if the ribbon was very thin and only the ribbon was placed on a measurement stage, parts of the ribbon would be then lifted up due to undulations, etc. and affect the height measurement. The purpose is to minimize such effect.

### [Magnetic Flux Density Br]

A magnetic field of 8000 A/m was applied to a heat treated nanocrystalline alloy ribbon (single sheet sample) using a DC magnetization characteristics test equipment manufactured by Metron Giken Co., Ltd., and the value of magnetic flux density B when the magnetic field was 0 was taken as Br.

### [Iron Loss]

A ring core having an internal diameter of 8.8 mm and an outer diameter of 19.9 mm was punched out from a 15-layer nanocrystalline alloy ribbon and placed in a case. The iron loss was measured using a BH analyzer SY8218 manufactured by Twatsu Electric Co., Ltd. The measurement conditions employed were primary and secondary windings of 15 turns, a frequency of 20 kHz, and a magnetic flux density of 0.2 T.

### Example 3

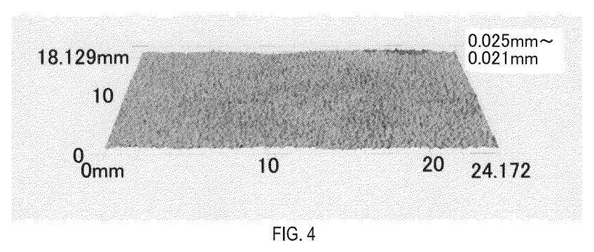

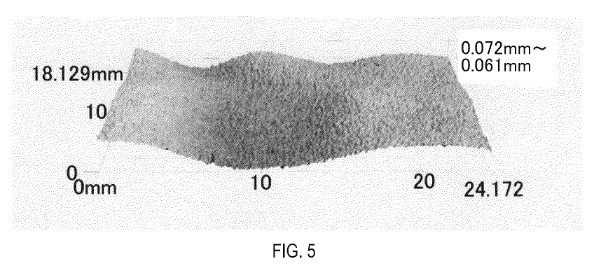

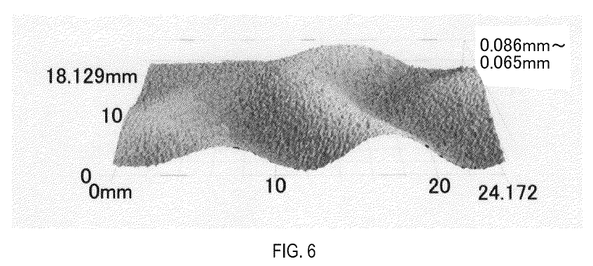

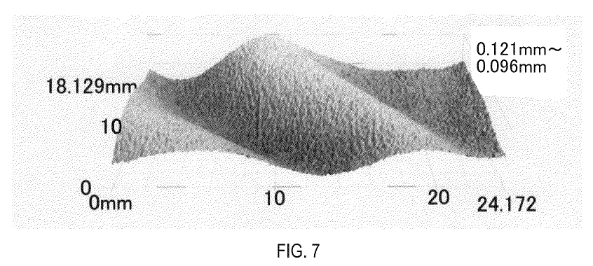

Table 5 shows the evaluation results of the nanocrystalline alloy ribbons produced in Example 3. In Example 3, the pressure to press the non-crystalline alloy ribbon having the composition of No. 10 in Example 2 during heat treatment was changed to 0.019, 0.038, 0.058, and 0.086 MPa to produce nanocrystalline alloy ribbons. In Example 3, by setting the pressure to press the ribbon to 0.03 MPa or more, a space factor of 68.0% or more was obtained. Laser microscope photographs evaluating the wrinkle heights of Nos. 10, 16, 17, and 18 are respectively shown in FIGS. 4, 5, 6, and 7.

TABLE 5

| | Heat | | | Saturation | | | | | | | |
|---|---|---|---|---|---|---|---|---|---|---|---|
| | treatment | Pressing | Retention | magnetic | Maximum | | | | | Wrinkle | Space |
| | temp. | pressure | time | flux density | magnetic | | | B80_{L}/ | Br/B8000 | height | factor |
| No. | ° C. | MPa | sec. | T | permeability | B80_{L} | B80_{W} | B80_{W} | (Br/Bs) | mm | % |
| 10 | 660 | 0.115 | 1.2 | 1.41 | 20400 | 0.93 | 0.91 | 1.03 | 0.47 | 0.025 | 70.2 |
| 15 | | 0.086 | | | 13999 | 1.01 | 0.92 | 1.10 | 0.34 | 0.054 | 70.3 |
| 16 | | 0.058 | | | 15412 | 0.98 | 1.00 | 0.99 | 0.36 | 0.072 | 70.0 |
| 17 | | 0.038 | | | 19952 | 1.11 | 1.14 | 0.98 | 0.23 | 0.086 | 68.9 |
| 18 | | 0.019 | | | 17875 | 1.03 | 1.15 | 0.90 | 0.24 | 0.121 | 66.5 |

As above, according to the present disclosure, a nanocrystalline alloy ribbon having a saturation magnetic flux density of 1.15 T or more and a maximum magnetic permeability of 4000 or more was obtained. Moreover, a nanocrystalline alloy ribbon having a ratio Br/B₈₀₀₀ of the residual magnetic flux density Br to the magnetic flux density B₈₀₀₀ in the magnetic field 8000 A/m of 0.20 or more was obtained. In addition, a nanocrystalline alloy ribbon with the ratio (B80_{L}/B80_{W}) of the magnetic flux density B80_{L} when a magnetic field of 80 A/m is applied in the longitudinal direction to the magnetic flux density B80_{W} when a magnetic field of 80 A/m is applied in a width direction orthogonal to the longitudinal direction, of 0.60 to 1.40, and exhibiting isotropy properties was obtained.

According to the present disclosure, a nanocrystalline alloy ribbon having a wrinkle height of 0.15 mm or less was obtained. Also, by setting

1. A method for manufacturing a nanocrystalline alloy ribbon, the method comprising:
heating a non-crystalline alloy ribbon by bringing the ribbon into contact with a heating body to produce a nanocrystalline alloy ribbon having a structure in which crystal grains having an average crystal grain size of 50 nm or less are present in an amorphous phase, wherein
the nanocrystalline alloy ribbon is represented by a composition formula: (Fe₁₋ₓAₓ)ₐSi_{b}B_{c}Cu_{d}Mₑ, where A is at least one type of Ni and Co, M is at least one type of element selected from a group consisting of Nb, Mo, V, Zr, Hf and W, and in at %, 72.0≤a≤81.0, 9.0≤b≤17.0, 5.0≤c≤10.0, 0.02≤d≤1.2, 0.1≤e≤3.5, and 0≤x≤0.1 are satisfied,
when the non-crystalline alloy ribbon is heated by contacting the heating body, the non-crystalline alloy ribbon is conveyed and a ribbon holding member comes into contact with a surface of the non-crystalline alloy ribbon opposite to a surface that contacts of the heating body, so that the non-crystalline alloy ribbon is heated while being pressed against the heating body, and
the heating body is heated to a heating temperature Ta of Tx1+80° C. or more and Tx1+230° C. or less, where Tx1° C. is a bccFe crystallization starting temperature of the non-crystalline alloy ribbon measured at a heating rate of 20 K/min.

2. The method for manufacturing a nanocrystalline alloy ribbon according to claim 1, wherein the ribbon holding member is a flexible member.

3. The method for manufacturing a nanocrystalline alloy ribbon according to claim 1, where a conveying speed of the non-crystalline alloy ribbon is 1 m/min. or more.

4. The method for manufacturing a nanocrystalline alloy ribbon according to claim 1, wherein contact time of the non-crystalline alloy ribbon with the heating body is 0.1 seconds to 30 seconds.

5. The method for manufacturing a nanocrystalline alloy ribbon according to claim 1, wherein a pressure to press the non-crystalline alloy ribbon against the heating body is 0.03 MPa or more.

6. The method for manufacturing a nanocrystalline alloy ribbon according to claim 1, wherein a wrinkle height of the nanocrystalline alloy ribbon 0.15 mm or less, and a space factor is 68.0% or more.

7. The method for manufacturing a nanocrystalline alloy ribbon according to claim 1, wherein the nanocrystalline alloy ribbon has a saturation magnetic flux density Bs of 1.15 T or more and a maximum magnetic permeability of 4000 or more.

8. The method for manufacturing a nanocrystalline alloy ribbon according to claim 1, wherein the nanocrystalline alloy ribbon has a ratio Br/B₈₀₀₀ of a residual magnetic flux density Br to a magnetic flux density B₈₀₀₀ in a magnetic field of 8000 A/m of 0.20 or more.

9. The method for manufacturing a nanocrystalline alloy ribbon according to claim 1, wherein a ratio (B80_{L}/B80_{W}) of a magnetic flux density B80_{L} when a magnetic field 80 A/m is applied in a longitudinal direction of the nanocrystalline alloy ribbon to a magnetic flux density B80_{W} when a magnetic field 80 A/m is applied in a width direction orthogonal to the longitudinal direction is 0.60 to 1.40, and both B80_{L} and B80_{W} are 0.4 T or more.

10. The method for manufacturing a nanocrystalline alloy ribbon according to claim 1, wherein the nanocrystalline alloy ribbon has a saturation magnetostriction of 7 ppm or less.

11. A method for manufacturing a magnetic sheet comprising:
preparing a nanocrystalline alloy ribbon, a support formed in a ribbon shape, and an adhesive layer having an adhesive provided on at least one of a first surface and a second surface of the support; and
continuously guiding the nanocrystalline alloy ribbon and the adhesive layer to an attaching roller to bond the nanocrystalline alloy ribbon and the adhesive layer by the attaching roller,
the nanocrystalline alloy ribbon being obtained by heating a non-crystalline alloy ribbon by bringing the ribbon into contact with a heating body, the nanocrystalline alloy ribbon having a structure in which crystal grains having an average crystal grain size of 50 nm or less are present in an amorphous phase, wherein
the nanocrystalline alloy ribbon is represented by a composition formula: (Fe₁₋ₓAₓ)ₐSi_{b}B_{c}Cu_{d}Mₑ, where A is at least one type of Ni and Co, M is at least one type of element selected from a group consisting of Nb, Mo, V, Zr, Hf and W, and in at %, 72.0≤a≤81.0, 9.0≤b≤17.0, 5.0c≤10.0, 0.02≤d≤1.2, 0.1≤e≤3.5, and 0≤x≤0.1 are satisfied,
when the non-crystalline alloy ribbon is heated by contacting the heating body, the non-crystalline alloy ribbon is conveyed and a ribbon holding member comes into contact with a surface of the non-crystalline alloy ribbon opposite to a surface that contacts of the heating body, so that the non-crystalline alloy ribbon is heated while being pressed against the heating body, and
the heating body is heated to a heating temperature Ta of Tx1+80° C. or more and Tx1+230° C. or less, where Tx1° C. is a bccFe crystallization starting temperature of the non-crystalline alloy ribbon measured at a heating rate of 20 K/min.

12. The method for manufacturing a magnetic sheet according to claim 11, wherein after the adhesive layer is attached to one side of the nanocrystalline alloy ribbon, a crack roller is pressed against a side of the nanocrystalline alloy ribbon opposite to a side to which the adhesive layer is attached, to form cracks in the nanocrystalline alloy ribbon.

13. The method for manufacturing a magnetic sheet according to claim 11, wherein when a dimension related to the adhesive layer in a direction intersecting a longitudinal direction of the adhesive layer is width A, a dimension related to the nanocrystalline alloy ribbon in a direction intersecting a longitudinal direction of the nanocrystalline alloy ribbon is width B,
a relationship 0.2 mm≤(width A−width B)≤3 mm is satisfied.

14. The method for manufacturing a magnetic sheet according to claim 11, wherein in a cross-sectional view of the magnetic sheet cut along a direction intersecting to a longitudinal direction of the adhesive layer,
when a distance from a first adhesive layer end of the adhesive layer to a first ribbon end that is an end of the nanocrystalline alloy ribbon on a same side as the first adhesive layer end is gap a, and
a distance from a second adhesive layer end opposite to the first adhesive layer end of the adhesive layer to a second ribbon end that is an end of the nanocrystalline alloy ribbon on a same side as the second adhesive layer end is gap b,
a relationship 0 mm<gap a and 0 mm<gap b is satisfied.
